(19) United States
(12) Patent Application Publication
(10) Pub. No.: US 2024/0079626 A1
(43) Pub. Date: Mar. 7, 2024

(54) Cell Assembly and Method for Manufacturing the Same

(71) Applicants: Hyundai Motor Company, Seoul (KR); Kia Corporation, Seoul (KR)

(72) Inventor: Kyung Ho Kim, Goyang-si (KR)

(21) Appl. No.: 18/063,252

(22) Filed: Dec. 8, 2022

(30) Foreign Application Priority Data
Sep. 6, 2022 (KR) 10-2022-0113015

(51) Int. Cl. H01M 8/2475; H01M 8/248

(52) U.S. Cl. CPC H01M 8/2475; H01M 8/248

(57) ABSTRACT

An embodiment cell assembly includes a cell stack in which a plurality of cells are stacked, a first end plate attached to a first side surface of the cell stack, a second end plate attached to a second side surface of the cell stack opposite the first side surface, and a first band member surrounding a circumference of the cell stack, wherein a partial area of the first band member surrounds an outer surface of the second end plate.

### CROSS-REFERENCE TO RELATED APPLICATIONS

This application claims the benefit of Korean Patent Application No. 10-2022-0113015, filed on Sep. 6, 2022, which application is hereby incorporated herein by reference.

### TECHNICAL FIELD

The present disclosure relates to a cell assembly and a method for manufacturing the same.

### BACKGROUND

To smoothly operate a fuel cell that receives hydrogen and air to produce electric power, it is necessary to form a specific surface pressure in the fuel cell. Accordingly, to form the surface pressure in the fuel cell, end plates that press the fuel cell are provided on side surfaces of the fuel cell.

However, according to a conventional technology, due to various factors, a surface pressure of the fuel cell is not uniformly formed according to time or location, whereby an efficiency of the fuel cell is lowered and a durability of the fuel cell is lowered. In more detail, according to the conventional technology, the fuel cell cannot be variably pressed in correspondence to a change in volume for time that occurs in the fuel cell as the fuel cell is driven or a change of volume for areas due to tolerances between parts in the fuel cell. This lowers a durability of the fuel cell, in particular, a separator, and acts as a factor that lowers an overall operation efficiency of the fuel cell as well.

### SUMMARY

The present disclosure relates to a cell assembly and a method for manufacturing the same. Particular embodiments relate to a cell assembly that may be applied to a structure, in which fuel cells are stacked, and a method for manufacturing the same.

Embodiments of the present disclosure can solve d problems occurring in the prior art while advantages achieved by the prior art are maintained intact.

An embodiment of the present disclosure provides a structure that may enhance durability and an overall operation efficiency of a fuel cell by variably pressing the fuel cell in correspondence to a change in volume for times and a change in volume for areas in the fuel cell.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a cell assembly includes a cell stack, in which a plurality of cells are stacked, a first end plate attached to one side surface of the cell stack, a second end plate attached to an opposite side surface to the one side surface of the cell stack, and a first band member that surrounds a circumference of the cell stack, at least a partial area of which surrounds an outer surface of the second end plate.

The cell assembly may further include an elastic member provided in a space between the first band member and the second end plate.

The first band member may surround a circumference of the cell stack in a horizontal direction (W), a lengthwise end of the first band member may be fixedly coupled to a lengthwise end of the first end plate, and a lengthwise opposite end of the first band member may be fixedly coupled to a lengthwise opposite end of the first end plate.

The elastic member may have a shape in which first protruding areas protruding toward the second end plate and second protruding areas protruding toward the first band member are alternately disposed along a vertical direction (H).

A thickness of the first protruding areas and a thickness of the second protruding areas may correspond to each other.

A shape and a size of the first protruding areas and a shape and a size of the second protruding areas may correspond to each other.

Recessed areas, in which portions of the first protruding areas are accommodated and which are recessed inwards, may be formed on a surface of the second end plate, which faces the elastic member.

A radius of curvature of the recessed areas in the vertical direction (H) may be larger than a radius of curvature of the first protruding areas in the vertical direction (H).

The cell assembly may further include a tie member fixing the elastic member to the first band member.

The tie member may pass through the elastic member and the first band member in a horizontal direction.

The cell assembly may further include a second band member that surrounds an upper surface, a side surface, and a lower surface of the cell stack, and the first band member and the second band member may cross each other on the side surface of the cell stack.

The cell assembly may further include an elastic member provided in a space between the first band member and the second end plate, and the second band member may surround an outer surface of the first band member in an area, in which the first band member and the second band member cross each other.

A lengthwise end of the second band member may be fixedly coupled to a widthwise end of the first end plate, and a lengthwise opposite end of the second band member may be fixedly coupled to a widthwise opposite end of the first end plate.

The cell assembly may further include a tie member fixing the elastic member to the first band member and the second band member.

The tie member may pass through the elastic member, the first band member, and the second band member in the horizontal direction.

Areas of the first band member and the second band member, which are bent along a shape of the cell stack, may be provided with a resin material having elasticity.

A through area communicating an outside and the cell stack may be formed in the first end plate, and the through area may be formed on a horizontally inner side of an area, in which the first band member is fixedly coupled to the first end plate.

According to another embodiment of the present disclosure, a method for manufacturing a cell assembly includes disposing a first band member and a second band member, in which one or more bent areas are formed, such that the first band member and the second band member cross each other to overlap each other in a partial area, and disposing an elastic member in the area, in which the first band member and the second band member overlap each other, disposing a first end plate, a cell stack, in which a plurality of cells are stacked, and a second end plate in an interior space defined by the first band member and the second band member, in a sequence thereof, and fixedly coupling lengthwise ends of the first band member and lengthwise ends of the second band member to the first end plate.

The method may further include, between the disposing of the band member and the elastic member and the disposing of the cell stack and the end plate, expanding the interior space defined by the first band member and the second band member by pressing the first band member and the second band member such that the first band member and the second band member are deflected with respect to the bent area.

The method may further include, between the disposing of the cell stack and the end plate and the coupling, pressing the first end plate in a direction that faces the second end plate such that the first end plate is attached to the cell stack and the cell stack is attached to the second end plate.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 is a first perspective view illustrating a cell assembly according to embodiments of the present disclosure;

FIG. 2 is a second perspective view illustrating a cell assembly according to embodiments of the present disclosure;

FIG. 3 is a vertical sectional view illustrating a cell assembly according to embodiments of the present disclosure;

FIG. 4 is an enlarged vertical sectional view illustrating an elastic member and peripheral configurations of a cell assembly according to embodiments of the present disclosure;

FIG. 5 is a view illustrating a state, in which a first band member, a second band member, and an elastic member are disposed, in a method for manufacturing a cell assembly according to embodiments of the present disclosure;

FIG. 6 is a view illustrating a state, in which a cell stack, a first end plate, and a second end plate are additionally disposed, in the method for manufacturing a cell assembly according to embodiments of the present disclosure; and

FIG. 7 is a view illustrating the first end plate, and a state, in which the second end plate is fixedly coupled to the first end plate, in the method for manufacturing a cell assembly according to embodiments of the present disclosure.

### DETAILED DESCRIPTION OF ILLUSTRATIVE EMBODIMENTS

Hereinafter, a cell assembly and a method for manufacturing the cell assembly according to embodiments of the present disclosure will be described with reference to the drawings.

### Cell Assembly

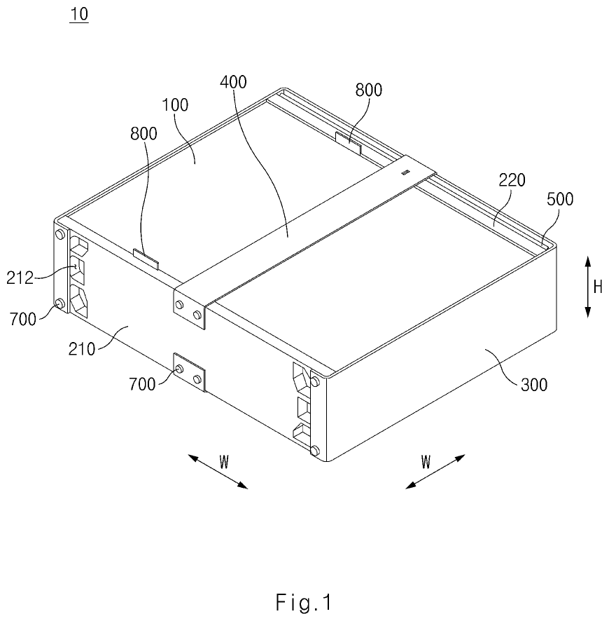

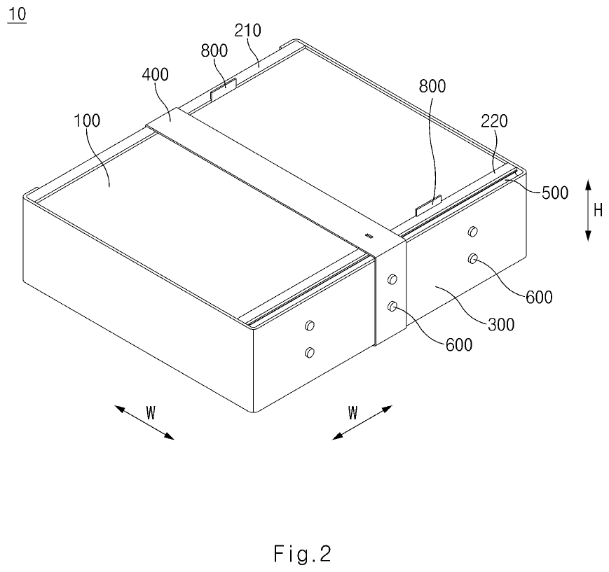

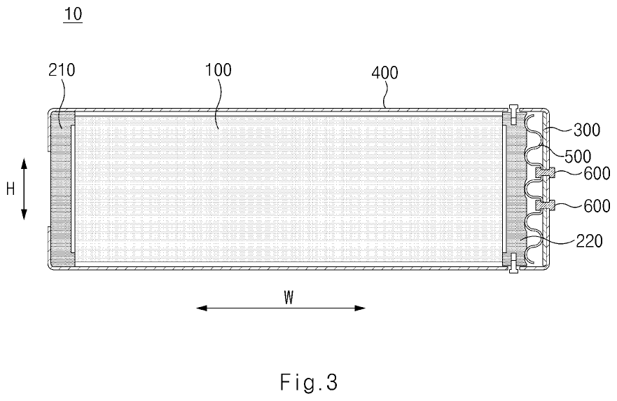

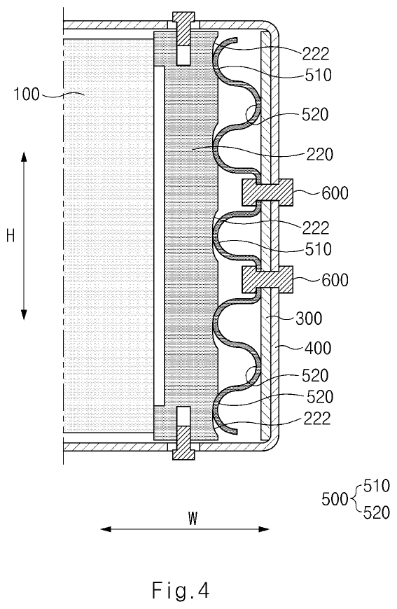

FIG. 1 is a first perspective view illustrating a cell assembly according to embodiments of the present disclosure. FIG. 2 is a second perspective view illustrating a cell assembly according to embodiments of the present disclosure. FIG. 3 is a vertical sectional view illustrating a cell assembly according to embodiments of the present disclosure. FIG. 4 is an enlarged vertical sectional view illustrating an elastic member and peripheral configurations of a cell assembly according to embodiments of the present disclosure.

A cell assembly 10 may include a cell stack 100, in which a plurality of cells are stacked. The plurality of cells that constitute the cell stack 100 may be fuel cells. However, the present disclosure is not limited to a fuel cell, and may be applied to a battery (e.g., a lithium secondary battery) that produces electric power.

Furthermore, the cell assembly 10 may include a first end plate 210 that is attached to one side surface of the cell stack 100 and a second end plate 220 that is attached to an opposite side surface to the one side surface of the cell stack wo. The first end plate 210 and the second end plate 220 may be configurations that form a specific surface pressure in the cell stack 100 by pressing opposite side surfaces of the cell stack 100 toward an interior of the cell stack boo. FIG. 1 and FIG. 2 illustrate a state in which the first end plate 210 and the second end plate 220 are attached to opposite side surfaces of the cell stack 100 in a horizontal direction “W”.

Referring now to FIGS. 1 to 4, the cell assembly 10 according to embodiments of the present disclosure may further include a first band member 300 that is configured to surround a circumference of the cell stack 100 and at least a partial area of which surrounds an outer side of the second end plate 220. The first band member 300 may perform a function of maintaining a surface pressure formed in an interior of the cell stack 100 by fixing the end plates 210 and 220 such that they are attached to the cell stack loft FIGS. 1 and 2 illustrate a state in which the first band member 300 surrounds a circumference of the cell stack 100 in the horizontal direction “W”.

Meanwhile, the cell assembly 10 according to embodiments of the present disclosure may further include an elastic member 500 provided in a space between the first band member 300 and the second end plate 220. The elastic member 500 may be a configuration for providing an elastic force while applying a pressure when a force is applied in the horizontal direction “W” with reference to FIG. 1. Accordingly, the elastic member 500 may be a configuration for uniformly forming the surface pressure of the cell stack 100 regardless of a change in the volumes of the cells or tolerances between parts of the cells, which are generated as the cells in the cell stack 100 are driven. As an example, an internal pressure of the cell stack 100 is changed when gases such as hydrogen or air or cooling water is introduced into the cell stack 100, and thus a volume of the cell stack 100 also is changed, and according to embodiments of the present disclosure, the elastic member 500 provides an elastic force to the cell stack 100 while being compressed when the volume of the cell stack 100 is changed. In this case, because the cell stack 100 may be uniformly pressed, a pressure due to an increase in the volume of the cell stack 100 may be prevented from being concentrated in a specific configuration (e.g., a separator) in the cell when the volume is increased.

The elastic member 500 may be formed of various materials. For example, the elastic member 500 may be formed of a carbon fiber. However, the material of the elastic member 500 is not limited to the carbon fiber, and various kinds of materials may be used.

Meanwhile, the elastic member 500 may have a serpentine shape. In more detail, as illustrated in FIGS. 3 and 4, the elastic member 500 may have a shape in which first protruding areas 510 that protrude toward the second end plate 220 and second protruding areas 520 that protrude toward the first band member 300 are alternately disposed along a vertical direction “H”. When the elastic member 500 has the above-described shape, a restoring force may be generated in the horizontal direction “W” while the curved shapes of the first protruding areas 510 and the second protruding areas 520 become flat when a compression force is applied to the elastic member 500 in the horizontal direction “W”, and accordingly, the cell stack wo and the first band member 300 may be pressed in the horizontal direction. As an example, a thickness of the first protruding areas 510 and a thickness of the second protruding areas 520 may correspond to each other or may be the same. More preferably, an entire thickness of the elastic member 500 may be substantially constant. Furthermore, a shape and a size of the first protruding areas 510 and a shape and a size of the second protruding areas 520 may correspond to each other or may be the same. This may be advantageous in an aspect of easiness of manufacturing.

Meanwhile, referring now to FIGS. 3 and 4, in the cell assembly 10, recessed areas 222, in which portions of the first protruding areas 510 are accommodated and which have inwardly recessed shapes, may be formed on a surface of the second end plate 220 which faces the elastic member 500. Accordingly, according to embodiments of the present disclosure, because partial areas of the elastic member 500 are accommodated in the recessed areas 222 of the second end plate 220, the elastic member 500 may be prevented from being separated in the vertical direction “H”, and the elastic member 500 may press the second end plate 220 in a specific area.

As an example, with reference to a shape of a cross-section when the cell stack 100 is cut in the vertical direction “H”, a radius of curvature of the recessed areas 222 in the vertical direction “H” may be larger than a radius of curvature of the first protruding area 510 in the vertical direction “H”. In this case, because a compression force is applied to the elastic member 500 in the horizontal direction “W”, the first protruding areas 510 may maintain a state in which they are not separated from the recessed areas 222 but are accommodated even when the curved shapes of the first protruding areas 510 become flat.

Referring now to FIGS. 1 and 2, the cell assembly 10 according to embodiments of the present disclosure may further include a second band member 400 that is provided separately from the first band member 300. In more detail, with reference to FIGS. 1 and 2, the second band member 400 may further include the second band member 400 that is configured to surround an upper surface, a side surface, and a lower surface of the cell stack 100. Then, the first band member 300 and the second band member 400 may be configured to cross each other on a side surface of the cell stack 100 in the horizontal direction “W”. However, unlike the above description, the cell assembly 10 may include only the first band member 300 while not including the second band member 400.

The second band member 400 may be a configuration for supporting the first band member 300 to prevent the first band member 300 from being separated from the cell stack 100 and the second end plate 220. In addition, the second band member 400 may be a configuration for maintaining a surface pressure of a central area of the cell stack 100 in the horizontal direction “W”, in which a highest pressure is generated in an operation process of the cell stack 100, by pressing the central area of the cell stack wo in the horizontal direction “W”. To achieve the above-described feature, the second band member 400 may be configured to face the central area of the cell stack 100 in the horizontal direction “W” while surrounding the upper surface, the side surface, and the lower surface of the cell stack 100, and in an area in which the first band member 300 and the second band member 400 cross each other, the second band member 400 may be configured to apply a pressure toward the cell stack 100 while surrounding an outer surface of the first band member 300.

Meanwhile, as illustrated in FIGS. 1 and 2, the first band member 300 may have a substantially bent U shape, and opposite ends of the U shape may be bent inwards. Accordingly, a lengthwise end of the first band member 300 (that is, an area that is bent inwards from an end of the above-described U shape) may be fixedly coupled to a lengthwise end of the first end plate 210 in the horizontal direction “W”, and a lengthwise opposite end of the first band member 300 (that is, an area that is bent inwards from an opposite end of the above-described U shape) may be fixedly coupled to a lengthwise opposite end of the first end plate 210 in the horizontal direction “W”. That is, the first band member 300 may surround an entire one side surface of the cell stack 100, the entire second end plate 220, and an entire opposite side surface to the one side surface of the cell stack 100, and lengthwise opposite ends of the first band member 300 may be fixedly coupled to the first end plate 210. It may be understood that, with reference to FIGS. 1 and 2, when the cell stack wo has a substantially rectangular parallelepiped shape, the first band member 300 is configured to surround an entirety of three surfaces of a circumference of the cell stack 100 in the horizontal direction “W” and surround a portion of the remaining surface of the circumference of the cell stack 100 in the horizontal direction “W”.

Furthermore, as illustrated in FIGS. 1 and 2, the second band member 400 also may have a substantially bent U shape, and opposite ends of the U shape may be bent inwards. Accordingly, a lengthwise end of the second band member 400 (that is, an area that is bent inwards from an end of the above-described U shape) may be fixedly coupled to a widthwise end of the first end plate 210 in the vertical direction “H”, and a lengthwise opposite end of the second band member 400 (that is, an area that is bent inwards from an opposite end of the above-described U shape) may be fixedly coupled to a widthwise opposite end of the first end plate 210 in the vertical direction “H”. That is, the second band member 400 may sequentially surround an upper surface of the cell stack 100, the second end plate 220, and a lower surface of the cell stack 100, and lengthwise opposite ends of the second band member 400 may be fixedly coupled to the first end plate 210. It may be understood that, with reference to FIGS. 1 and 2, when the cell stack 100 has a substantially rectangular parallelepiped shape, the second band member 400 is configured to surround an entirety of three surfaces of a circumference of the cell stack 100 in the vertical direction “H” and surround a portion of the remaining surface of the circumference of the cell stack 100 in the vertical direction “H”.

Meanwhile, as illustrated in FIGS. 3 and 4, the cell assembly 10 according to embodiments of the present disclosure may further include a tie member 600 that fixes the elastic member 500 to the first band member 300 or the second band member 400. In more detail, the tie member 600 may be configured to pass through the elastic member 500, the first band member 300, and the second band member 400 in the horizontal direction “W”. In contrast, when the cell assembly 10 according to embodiments of the present disclosure includes only the first band member 300 and does not include the second band member 400, the tie member 600 may be a configuration for fixing the elastic member 500 to the first band member 300. In this case, the tie member 600 may be configured to pass through the elastic member 500 and the first band member 300 in the horizontal direction “W”. As described above, when the second band member 400 is provided on an outer surface of the first band member 300 in an area in which the first band member 300 and the second band member 400 cross each other, the tie member 600 may be configured to sequentially pass through the second band member 400, the first band member 300, and the elastic member 500. As an example, a size of a lengthwise end of the tie member 600 may be larger than a size of a hole through which the tie member 600 passes through the elastic member 500, the first band member 300, and the second band member 400. This may be for preventing the tie member 600 from being separated from the elastic member 500, the first band member 300, and the second band member 400. In more detail, the tie member 600 may pass through an area in which it contacts the first band member 300 in the second protruding areas 520 of the elastic member 500. Meanwhile, as an example, FIG. 2 illustrates a state in which the tie member 600 is provided in a middle area of the elastic member 500 in the horizontal direction “W”, an area that is spaced apart from the middle area in the horizontal direction “W”, and an area that is spaced in an opposite direction, and the tie member 600 passes through the second band member 400, the first band member 300, and the elastic member 500 in the middle area, and the tie member 600 passes through the first band member 300 and the elastic member 500 in the remaining areas.

Meanwhile, according to embodiments of the present disclosure, the first band member 300 or the second band member 400 may include a resin material having elasticity. The above-described resin material having elasticity may be a configuration for allowing the cell assembly 10 to be assembled more easily by allowing the first band member 300 and the second band member 400 to be deflected reversibly in a process of assembling the cell assembly 10 according to embodiments of the present disclosure.

In more detail, the resin material having elasticity may be provided in an area of the first band member 300 or the second band member 400 which is bent along the shape of the cell stack 100. That is, when the cell stack 100 has a substantially rectangular parallelepiped shape, the resin material having elasticity may be configured to face a corner area of the cell stack 100. Most preferably, the resin material having elasticity may be provided in an area of the first band member 300 which faces lengthwise opposite ends of the second end plate 220 in the horizontal direction “W” and may be provided in an area of the second band member 400 which faces widthwise opposite ends of the second end plate 220 in the vertical direction “H”.

Furthermore, in a preferred embodiment, a length of the elastic member 500 in the horizontal direction “W” may correspond to or be substantially the same as a length of the second end plate 220 in the horizontal direction “W”, and a width of the elastic member 500 in the vertical direction “H” may correspond to or be substantially the same as a width of the second end plate 220 in the vertical direction “H”. It may be understood that the elastic member 500 is configured to cover an entire area of the second end plate 220. In this case, because the elastic member 500 may uniformly press an entire area of the second end plate 220, the second end plate 220 may be prevented from being deflected from the cell stack 100 as a force that presses the cell stack 100 in an end area of the second end plate 220 is lowered.

Meanwhile, as described above, the plurality of cells provided in the cell stack 100 may be fuel cells. Accordingly, a fuel (that is, hydrogen and air) and cooling water need to be supplied from an outside to operate the cell stack 100.

To achieve this, a through area 212 that communicates an outside and the cell stack 100 may be formed in the first end plate 210. The through area 212 may have a specific hole shape. Accordingly, the fuel and the cooling water may be supplied to the cell stack 100 via the through area 212.

Then, the through area 212 may be formed on an inner side of an area in which the first band member 300 is fixedly coupled to the first end plate 210 in the horizontal direction “W”. Accordingly, the fuel and the cooling water may be smoothly introduced from the outside into the through area 212 without being interfered by the first band member 300.

Meanwhile, according to embodiments of the present disclosure, the cell assembly 10 may further include a plurality of bolt members 700 for fixedly coupling the first band member 300 and the second band member 400 to the first end plate 210. In more detail, the bolt members 700 may be configured to pass through the first band member 300 and the first end plate 210, and the second band member 400 and the first end plate 210.

Furthermore, the cell assembly 10 may further include a collector 800, one side of which is electrically connected to the cell stack 100 and an opposite side of which protrudes to the outside. The collector 800 may be a configuration for electrically connecting the outside and the cell assembly 10.

### Method for Manufacturing Cell Assembly

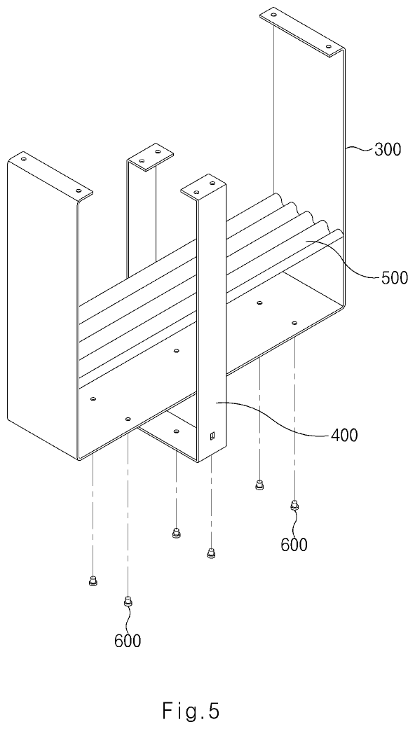

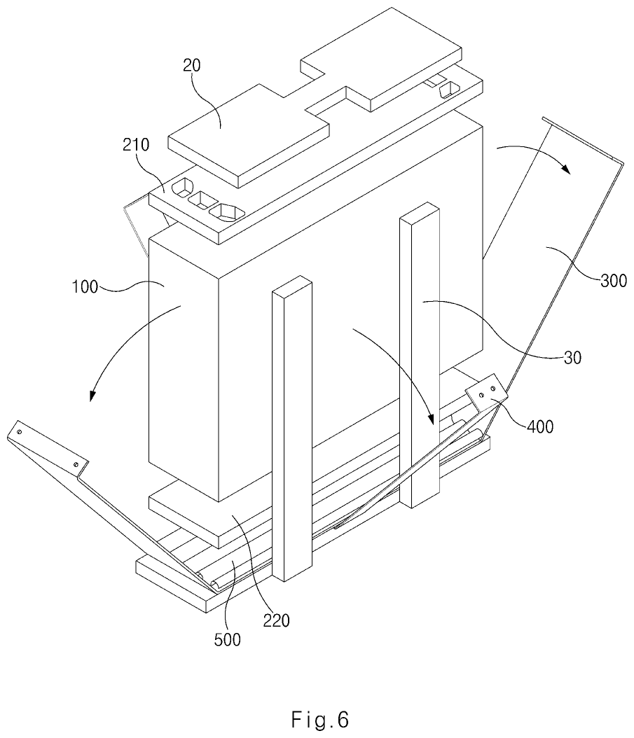

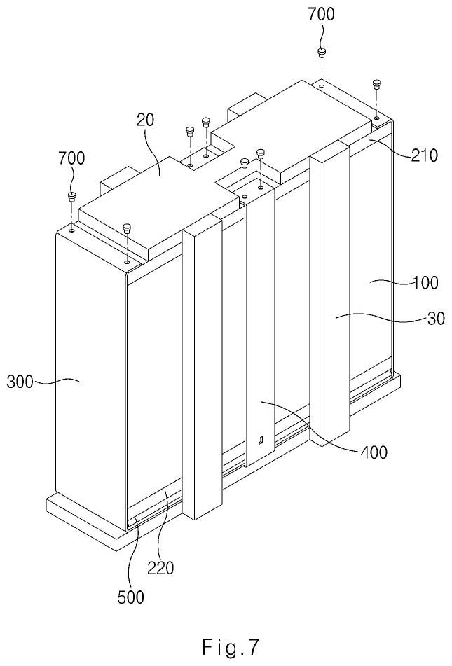

FIG. 5 is a view illustrating a state in which a first band member, a second band member, and an elastic member are disposed in a method for manufacturing a cell assembly according to embodiments of the present disclosure. FIG. 6 is a view illustrating a state in which a cell stack, a first end plate, and a second end plate are additionally disposed in the method for manufacturing a cell assembly according to embodiments of the present disclosure. FIG. 7 is a view illustrating the first end plate and a state in which the second end plate is fixedly coupled to the first end plate in the method for manufacturing a cell assembly according to embodiments of the present disclosure.

Referring to the above-described contents and FIGS. 1 to 7, the method for manufacturing a cell assembly according to embodiments of the present disclosure may include a band member and elastic member disposing operation of disposing the first band member 300 and the second band member 400, in which one or more bent areas are formed, such that the first band member 300 and the second band member 400 cross each other to overlap each other in a partial area, and disposing the elastic member 500 in the area in which the first band member 300 and the second band member 400 overlap each other. In more detail, as illustrated in FIG. 5, in the band member and elastic member disposing operation, the first band member 300 and the second band member 400 are disposed to cross each other so as to overlap each other in a lower area, the second band member 400 may be disposed on a lower side of the first band member 300 in a cross area, and the elastic member 500 may be disposed on an upper side of the first band member 300. Meanwhile, after the above-described band member and elastic member disposing operation, as illustrated in FIG. 5, an operation of the tie member 600 sequentially passing through the second band member 400, the first band member 300, and the elastic member 500 or the tie member 600 sequentially passing through the first band member 300 and the elastic member 500 may be performed.

Furthermore, meanwhile, referring to FIG. 5, in the band member and elastic member disposing operation, a specific interior space may be defined by the first band member 300 and the second band member 400. Then, the method for manufacturing a cell assembly may further include a cell stack and end plate disposing operation of disposing the first end plate 210, the cell stack 100, in which a plurality of cells are stacked, and the second end plate 220 in the interior space defined by the first band member 300 and the second band member 400 in a sequence thereof from an upper side, and a coupling operation of fixedly coupling lengthwise opposite ends of the first band member 300 and lengthwise opposite ends of the second band member 400 to the first end plate 210. As an example, in the cell stack and end plate disposing operation, as illustrated in FIG. 6, the cell stack 100 and the end plates 210 and 220 may be moved downwards along a specific locus as a guide member 3o is provided on a horizontal side, and the above-described coupling operation may be performed by the bolt member 700 as illustrated in FIG. 7.

Meanwhile, the method for manufacturing a cell assembly may further include a space expanding operation of, between the band member and elastic member disposing operation and the cell stack and end plate disposing operation, expanding an interior space defined by the first band member 300 and the second band member 400 by pressing the first band member 300 and the second band member 400 such that the first band member 300 and the second band member 400 are deflected with respect to the bent area. The above-described space expanding operation may be for disposing the cell stack 100 and the end plates 210 and 220 more easily in the cell stack and end plate disposing operation. In more detail, in the above-described space expanding operation, as illustrated in FIG. 6, the first band member 300 and the second band member 400 may be deflected to the outside with respect to the above-described resin area having elasticity.

Furthermore, as illustrated in FIG. 7, the method for manufacturing a cell assembly according to embodiments of the present disclosure may further include an operation of, between the cell stack and end plate disposing operation and the coupling operation, pressing the first end plate 210 in a direction that faces the second end plate 220 such that the first end plate 210 is attached to the cell stack 100 and the cell stack 100 is attached to the second end plate 220. The above-described pressing operation may be performed through a pressing jig 20 having a shape corresponding to that of the first end plate 210.

According to embodiments of the present disclosure a structure that may enhance a durability and an overall operation efficiency of a fuel cell by variably pressing the fuel cell in correspondence to a change in volume for times and a change in volume for areas in the fuel cell may be provided.

Although it is apparent that the present disclosure has been described with reference to the limited embodiments and the drawings, the present disclosure is not limited thereto, and the present disclosure may be variously carried out by an ordinary person in the art within the technical spirit of the present disclosure and the equivalent ranges of the claims.

What is claimed is:

1. A cell assembly comprising:
a cell stack in which a plurality of cells are stacked;
a first end plate attached to a first side surface of the cell stack;
a second end plate attached to a second side surface of the cell stack opposite the first side surface; and
a first band member surrounding a circumference of the cell stack, wherein a partial area of the first band member surrounds an outer surface of the second end plate.

2. The cell assembly of claim 1, further comprising an elastic member provided in a space between the first band member and the second end plate.

3. The cell assembly of claim 2, wherein the elastic member has a shape in which first protruding areas protruding toward the second end plate and second protruding areas protruding toward the first band member are alternately disposed along a vertical direction.

4. The cell assembly of claim 3, wherein a thickness of the first protruding areas and a thickness of the second protruding areas correspond to each other.

5. The cell assembly of claim 3, wherein a shape and a size of the first protruding areas and a shape and a size of the second protruding areas correspond to each other.

6. The cell assembly of claim 3, wherein recessed areas recessed inward are provided on a surface of the second end plate facing the elastic member, and wherein portions of the first protruding areas are accommodated in the recessed areas.

7. The cell assembly of claim 6, wherein a radius of curvature of the recessed areas in the vertical direction is larger than a radius of curvature of the first protruding areas in the vertical direction.

8. The cell assembly of claim 2, further comprising a tie member fixing the elastic member to the first band member.

9. The cell assembly of claim 8, wherein the tie member passes through the elastic member and the first band member in a horizontal direction.

10. A cell assembly comprising:
a cell stack in which a plurality of cells are stacked;
a first end plate attached to a first side surface of the cell stack;
a second end plate attached to a second side surface of the cell stack opposite the first side surface; and
a first band member surrounding a circumference of the cell stack in a horizontal direction, wherein a first lengthwise end of the first band member is fixedly coupled to a first lengthwise end of the first end plate, and a second lengthwise end of the first band member opposite the first lengthwise end of the first band member is fixedly coupled to a second lengthwise end of the first end plate opposite the first lengthwise end of the first end plate, and wherein a partial area of the first band member surrounds an outer surface of the second end plate.

11. The cell assembly of claim 10, further comprising a second band member surrounding an upper surface, the first side surface or the second side surface, and a lower surface of the cell stack, wherein the first band member and the second band member cross each other on the first side surface or the second side surface of the cell stack.

12. The cell assembly of claim 11, wherein a first lengthwise end of the second band member is fixedly coupled to a first widthwise end of the first end plate, and a second lengthwise end of the second band member opposite the first lengthwise end of the second band member is fixedly coupled to a second widthwise end of the first end plate opposite the first widthwise end of the first end plate.

13. The cell assembly of claim 11, further comprising an elastic member provided in a space between the first band member and the second end plate, wherein the second band member surrounds an outer surface of the first band member in an area in which the first band member and the second band member cross each other.

14. The cell assembly of claim 13, further comprising a tie member fixing the elastic member to the first band member and the second band member.

15. The cell assembly of claim 14, wherein the tie member passes through the elastic member, the first band member, and the second band member in the horizontal direction.

16. The cell assembly of claim 15, wherein areas of the first band member and the second band member which are bent along a shape of the cell stack are provided with a resin material having elasticity.

17. The cell assembly of claim 10, further comprising a through area communicating an outside and the cell stack provided in the first end plate, wherein the through area is provided on a horizontally inner side of an area in which the first band member is fixedly coupled to the first end plate.

18. A method for manufacturing a cell assembly, the method comprising:
disposing a first band member and a second band member in which a bent area is formed, such that the first band member and the second band member cross each other to overlap each other in a partial area, and disposing an elastic member in the partial area in which the first band member and the second band member overlap each other;
disposing a first end plate, a cell stack comprising a plurality of cells that are stacked, and a second end plate in an interior space defined by the first band member and the second band member; and
fixedly coupling lengthwise ends of the first band member and lengthwise ends of the second band member to the first end plate.

19. The method of claim 18, further comprising, after disposing the first band member and the second band member and disposing the elastic member and before disposing the first end plate, the cell stack, and the second end plate, expanding the interior space defined by the first band member and the second band member by pressing the first band member and the second band member such that the first band member and the second band member are deflected with respect to the bent area.

20. The method of claim 18, further comprising, after disposing the first end plate, the cell stack, and the second end plate and before fixedly coupling the lengthwise ends, pressing the first end plate in a direction that faces the second end plate such that the first end plate is attached to the cell stack and the cell stack is attached to the second end plate.
